(19) United States
(12) Patent Application Publication
(10) Pub. No.: US 2026/0217104 A1
(43) Pub. Date: Jul. 30, 2026

(54) MOTOR VEHICLE COMPRISING AN ELECTRIC ENERGY STORAGE DEVICE AND A RANGE EXTENDER, AND METHOD FOR OPERATING SUCH A MOTOR VEHICLE

(71) Applicant: AUDI AG, Ingolstadt (DE)

(72) Inventor: Felix WINKELMEYR, lngolstadt (DE)

(21) Appl. No.: 19/454,181

(22) Filed: Jan. 20, 2026

(30) Foreign Application Priority Data
Jan. 30, 2025 (DE) 102025103383.8

(51) Int. Cl. B60K 6/448; B60K 6/442; B60L 50/62

(52) U.S. Cl. CPC B60K 6/448; B60K 6/442; B60L 50/62

(57) ABSTRACT

A motor vehicle is disclosed, and may include an electrical energy storage device configured to store electrical energy, a range extender, a primary drive axle, a secondary drive axle, a primary electric machine configured to generate a primary drive torque by use of electrical energy stored in the electrical energy storage device, and a secondary electric machine configured to generate a secondary drive torque by use of the electrical energy stored in the electrical energy storage device. The range extender may include an internal combustion engine and a generator. The motor vehicle may be configured such that the primary drive torque is transmitted to the primary drive axle and the secondary drive torque is transmitted to the secondary drive axle. The energy storage device may be configured to be charged by way of operation of the internal combustion engine and the generator. The secondary electric machine may form the generator.

### BACKGROUND

### Technical Field

The present disclosure relates to a motor vehicle including an electrical energy storage device for storing electrical energy and a range extender including an internal combustion engine and a generator.

### Description of the Related Art

Electromobility is becoming increasingly important in connection with motor vehicles. Electric vehicles or hybrid vehicles are often used as motor vehicles. Such motor vehicles comprise at least one electric machine implementing an electric motor, by way of which a drive torque is generated and transmitted to a drive train. The energy required for this purpose is stored as electrical energy in an electrical energy storage device or a battery, which is converted into kinetic energy for the vehicle by way of the electric motor. In electric vehicles, drive torque is generated solely on the basis of the electrical energy stored in the energy storage device. In hybrid vehicles, the drive torque is also generated by an internal combustion engine.

A widespread problem associated with such motor vehicles is the limited range resulting from capacity issues relating to the energy storage device. To implement a range extension, a range extending device is proposed in the state of the art, which is often also referred to as a range extender. The range extender commonly comprises an internal combustion engine and a generator, wherein the internal combustion engine is operated using a fossil fuel to drive the generator, and the electrical energy generated by the generator is used to charge the energy storage device. A corresponding range extender is known, for example, from CN110816308A.

### BRIEF SUMMARY

The present disclosure sets forth an improved concept for operation of a range extender, in particular, a design that is simple and low-cost.

In accordance with the present disclosure, a motor vehicle is disclosed including an electrical energy storage device for storing electrical energy and a range extender including an internal combustion engine and a generator, wherein the energy storage device is configured be recharged by way of the operation of the internal combustion engine using a fossil fuel and by using the generator. The motor vehicle may further comprise a primary electric machine, by way of which the electric energy stored in the energy storage device may be used to generate a primary drive torque, and a secondary electric machine, by way of which the electric energy stored in the energy storage device may be used to generate a secondary drive torque, wherein the primary drive torque may be transmitted to a drive axle forming a primary axle and the secondary drive torque may be transmitted to a drive axle forming a secondary axle, The secondary electrical machine may be the generator.

The motor vehicle according to the present disclosure may comprise the primary axle and the secondary axle, each of these axles forming an electric drive axle. The motor vehicle according to the present disclosure thus may comprise two drive axles, within the framework of which the respective drive torque generated is transmitted to the wheels assigned to the respective axle. In some embodiments, , the primary axle is a rear axle and the secondary axle is a front axle of the motor vehicle. Alternatively, the primary axle may be a front axle and the secondary axle may be a rear axle of the motor vehicle. In the motor vehicle according to the present disclosure, which may comprise at least two drive axles, an all-wheel drive may be implemented. A main drive torque, i.e., a large part of the drive torque intended to drive the motor vehicle, may be generated by the primary electric machine.

The present disclosure may use the secondary electric machine synergistically not only in the course of generating the secondary drive torque, but also as the generator of the range extender. This is particularly useful because the operation of the secondary electric machine to generate the secondary drive torque is usually only intended in certain situations, such as when the motor vehicle is currently moving in rough terrain, wherein the entire drive torque of the motor vehicle may otherwise be generated by the primary electric machine. In those situations, in which no drive torque is generated by the secondary electric machine, the secondary electric machine may be used as a component of the range extender and therefore as a way of charging the electric energy storage device. In the context of the present disclosure, there is no need for a generator for the range extender that is present as a separate component, which also applies to components that are connected to the generator, such as an inverter and/or DC lines and/or AC lines and/or cooling lines and/or the like. Therefore, the present disclosure may enable the elimination of components, which is advantageous in terms of minimizing the overall weight of the vehicle and reducing associated costs.

The range extender may comprise the internal combustion engine and the generator. During operation of the internal combustion engine, fossil fuel, such as gasoline or diesel, which comes from a fuel tank of the vehicle, is burned, which may lead to a movement or rotation that is transmitted, for example via a shaft, to a rotor of the generator. The rotation of the rotor in turn may lead to the generation of electrical energy, which may be supplied to the vehicle’s energy storage device for charging purposes and therefore to extend a range of the vehicle.

The electrical energy storage device, which may also be referred to as a battery or an accumulator, may be, for example, a lithium-ion battery or an accumulator based on an alternative battery technology. A direct voltage provided by the energy storage device may be converted into an alternating voltage by way of a voltage converter or inverter, which in turn may be supplied to the electric machines or traction motors, which may result in movement or rotation of the rotor of the respective electric machine. The respective rotor is connected to a respective drive train of the motor vehicle in such a way that this movement or rotation may be transmitted to the wheels of the motor vehicle via shafts, gears and the like to realize the respective drive torque.

In some embodiments, the primary electric machine may be integrated into a primary drive train, by way of which the primary drive torque may be transmitted to the wheels of the primary axle. In addition or alternatively, the secondary electric machine may be integrated into a secondary drive train by way of which the secondary drive torque may be transmitted to the wheels of the secondary axle. The drive train refers to all components, in particular mechanical components, which may be used in the context of generating the respective drive torque and transmitting said drive torque to the wheels of the respective drivetrain. The drive train therefore comprises, for example, transmission shafts and clutches as well as transmission devices.

The electric machines may each comprise a stator and a rotor mounted so as to rotate relative to the stator, wherein the stator and the rotor each comprise windings and, optionally, permanent magnets, wherein electrical interactions between the windings and, optionally, permanent magnets causing the electrical energy provided by the electrical energy storage device to be converted into kinetic energy of the motor vehicle. The electrical machines may be separately excited synchronous machines or permanently excited synchronous machines or asynchronous synchronous machines or any combination thereof. The respective electric machine may be operated in a propulsion mode in which the electrical energy is used to generate a drive torque. In some embodiments, the respective electric machine may be operated in a recuperation mode, in which a braking torque may be generated by way of the respective electric machine, so that kinetic energy of the motor vehicle is converted into electrical energy, which in turn may be used to charge the energy storage device. In some embodiments, the stator and the rotor are accommodated in a housing of the respective electrical machine.

A rotor shaft of the secondary electric machine may be coupled or couplable to a drive component of the secondary drive train, via which the secondary drive torque may be transmitted to the wheels of the secondary axle, on the one hand, and to the internal combustion engine on the other. The rotor shaft may form a component of the rotor, via which the rotor shaft is rotatably mounted by way of a bearing device. A drive train-side end of the rotor shaft may be coupled or may be couplable to the drive component. An internal combustion engine-side end of the rotor shaft, which may opposite the drive train-side end of the rotor shaft, may be coupled or may be couplable to the internal combustion engine. The drive train-side end and/or the internal combustion engine-side end may protrude from the housing of the secondary electrical machine.

The secondary drive train may comprise a transmission through which the secondary drive torque may be transmitted to the wheels of the secondary axle. The drive component may be the transmission. In some embodiments, the transmission may be used to over-gear or under-gear the speed of the rotor to the speed of a component of the secondary drivetrain. In some embodiments, the drive component, such as the transmission, is connected or may be connected to the secondary electric machine or its rotor shaft directly, i.e., directly or by way of a coupling device described in more detail below.

In some embodiments, the secondary electrical machine may be brought into a coupled state, in which the secondary electrical machine and the drive component are coupled, and into a decoupled state, in which the secondary electrical machine is decoupled from the drive component, with respect to the drive component by way of a torque coupling device. In addition or alternatively, the secondary electric machine may be brought into a coupled state, in which the secondary electric machine and the internal combustion engine are coupled, and into a decoupled state, in which the secondary electric machine is decoupled from the internal combustion engine, with respect to the internal combustion engine and by way of a connection coupling device. The secondary electric machine may be selectively coupled to and decoupled from the drive component or the internal combustion engine by way of the torque coupling device or the connection coupling device. For this purpose, the respective coupling device may be connected to an actuator that may be operated electrically, for example. The respective coupling device may be a friction or claw coupling. In some embodiments, the torque coupling device is connected to the drive train-side end and the connection coupling device is connected to the internal combustion engine-side end of the rotor shaft.

In some embodiments, the motor vehicle according to the present disclosure comprises a control device which is configured to generate control signals and to output them to actuators actuating the torque coupling device and the connection coupling device, so that the secondary electric machine may be operated in a drive mode or in a charging mode by way of the control signals, wherein the secondary electric machine in the drive mode is in the decoupled state with respect to the internal combustion engine and in the coupled state with respect to the drive component. The secondary electric machine in the charging mode may be in the coupled state with respect to the internal combustion engine and in the decoupled state with respect to the drive component. The control signals therefore may cause the respective coupling device to engage or disengage accordingly in order to bring the respective coupling device into the currently required mode.

When the secondary electric machine is in the drive mode, the secondary electric machine is decoupled from the internal combustion engine and coupled to the drive component, so that in the drive mode, the secondary drive torque may be generated and transmitted to the wheels of the secondary drive train by way of the conversion of the electrical energy provided by the energy storage device on the part of the secondary electric machine.

When the secondary electric machine is in charging mode, the secondary electric machine is coupled to the internal combustion engine and decoupled from the drive component, so that in the charging mode, the energy storage device may be charged by way of the conversion of the kinetic energy provided by the internal combustion engine into electrical energy on the part of the secondary electric machine.

In some embodiments, the control device is configured to generate control signals and output the control signals to the actuators actuating the torque coupling device and the connection coupling device, so that the secondary electric machine may be operated in a neutral mode by way of the control signals, in which the secondary electric machine is in the decoupled state with respect to the internal combustion engine and with respect to the drive component. Therefore, when the secondary electric machine is in neutral mode, the secondary electric machine is neither connected to the combustion engine nor to the drive component, so that neither the secondary drive torque may be transmitted to the wheels of the secondary axle nor may the energy storage device be charged by operating the internal combustion engine. In the neutral mode, only the primary drive torque generated by the primary electric motor may be transmitted to the wheels of the primary axle.

In some embodiments, the control device is configured to determine at least one piece of operating information relating to the operation of the motor vehicle and, based on this at least one piece of operating information, to verify the fulfillment of a charging condition and the fulfillment of a drive condition. The operating information may relate to all conceivable circumstances that are relevant in connection with the operation of the range extender. The operating information may provide a control basis for determining whether the charging mode, the operation of the range extender, or the drive mode is currently indicated.

The charging condition may be fulfilled if the at least one piece of operating information indicates a benefit of the operation of the secondary electrical machine in the charging mode, wherein the control device is further configured to generate the control signals such that the secondary electrical machine is transferred to the charging mode or left in the charging mode when the charging condition is fulfilled. The drive condition may be fulfilled if the at least one piece of operating information indicates a benefit of the operation of the secondary electrical machine in the drive mode, wherein the control device is also configured to generate the control signals such that the secondary electrical machine is transferred to the drive mode or left in the drive mode when the drive condition is fulfilled. In the course of checking the charging condition and the drive condition, on the part of the control device the operating information is evaluated to determine whether the respective condition is fulfilled and, if this is the case, the control signals are generated and output by way of the control device such that the secondary electrical machine switches to the respective mode or is left in this mode.

The operating information or one piece of the operating information may be charging information relating to the current state of charge of the energy storage device. Here, the charging condition may be fulfilled if the charging information indicates that the current state of charge is less than a specified charging limit value. The charging information may be available as a numerical value relating to the current state of charge, which is often referred to as SoC (“State of Charge”) and is typically given as a percentage. A state of charge of 0% means that the energy storage device is completely discharged. Accordingly, a state of charge of 100% means that the energy storage device is fully charged. The charge limit value may be specified such that it is ensured that a certain buffer of electrical energy remains in the energy storage device when the charging limit value is reached. For example, the charge limit value may have a value between 5% and 30%, such as 10%. Sensor data from a state of charge sensor may be used to determine the charging information, for example by way of the control device. In addition or alternatively, available information and/or control commands may be used to determine the charging information from a vehicle control system which, for example, implements at least semi-autonomous control of the vehicle.

In addition or alternatively, the operating information or one piece of the operating information may be user information relating to a user’s desire to operate the secondary electrical machine in the charging mode, wherein the charging condition is fulfilled if the user information indicates that the user desires operation of the secondary electrical machine in the charging mode. In some embodiments, the operating information or one piece of the operating information is user information relating to a desire on the part of the user to operate the secondary electrical machine in the drive mode, wherein the drive condition is fulfilled if the user information indicates that the user desires operation of the secondary electrical machine in the drive mode.

The motor vehicle may have an input device by way of which user information may be specified by the user. The input device may be a touchscreen, wherein the user may tap a button on the touchscreen to specify the relevant user information. The input device may be located in a passenger compartment of the motor vehicle, such as on a vehicle console forming a dashboard. The user information relating to the operation of the secondary electric machine in the drive mode may be specified by the user briefly flooring the gas pedal and thus performing a so-called “kick-down”. When the secondary electric machine subsequently switches to the drive mode, the user has both the primary and secondary drive torque and therefore the maximum possible drive power at their disposal.

In some embodiments, the control device is configured to check the fulfillment of a postponement condition when the charging condition is fulfilled and on the basis of the at least one piece of operating information, wherein the postponement condition is fulfilled when the charging condition is fulfilled if the at least one piece of operating information indicates that the operation of the secondary electrical machine in the drive mode is preferable to the switch to the charging mode. The control device may be further configured to postpone or omit the control signals causing the secondary electric machine to switch to the charging mode when the postponement condition is fulfilled. In some embodiments, the control device is configured to check the fulfillment of a postponement condition when the drive condition is fulfilled and on the basis of the at least one piece of operating information, wherein the postponement condition is fulfilled when the drive condition is fulfilled if the at least one piece of operating information indicates that the operation of the secondary electrical machine in the charging mode is preferable to the switch to the drive mode. The control device may be further configured to postpone or omit the control signals causing the secondary electrical machine to switch to the drive mode when the postponement condition is fulfilled.

In the context of these embodiments, when the respective condition is fundamentally fulfilled within the context of the postponement condition, it is checked whether there are compelling reasons that speak against changing the respective current mode. In this case, the postponement condition is fulfilled and this switch is either postponed or omitted. For example, the acquisition of at least one piece of operating information can be repeated so that it is updated. The switch may ultimately take place if the updated operating information indicates that the drive or charging condition is fulfilled while the postponement condition is not fulfilled.

The postponement condition may be fulfilled, when the drive condition is fulfilled, if the at least one piece of operating information, such as the charging information, indicates that the residual energy available in the energy storage device is so low that switching the secondary electric machine to drive mode would result in the energy storage device being at least almost completely discharged. In the context of this embodiment, the compelling reason for omitting the switch from charging to drive mode is that the residual energy available in the energy storage device is so low that switching to drive mode would pose a risk of the vehicle breaking down. A user output may also be provided, for example by way of the input device, which informs the user of this fact. Checking the postponement condition may be provided for by checking whether the current state of charge is less than a critical charge limit value. Said critical charge limit value may be less than the charge limit value and may be 5%.

In some embodiments, the postponement condition is fulfilled, when the charging condition is fulfilled, if the at least one piece of operating information indicates that the secondary electric machine is currently in the drive mode or that its operation in the drive mode is imminent. Because the secondary machine cannot be operated simultaneously in the drive mode and the charging mode, the secondary machine may be checked whether the secondary machine is currently in drive mode, in which case the secondary electric machine is not switched to the charging mode. This switch may, for example, be postponed until a point in time when, after checking the conditions, the charging condition is fulfilled and the drive condition is not fulfilled. Specifically, in such embodiments, the postponement condition cannot be fulfilled and therefore the switch to charging mode may take place if the at least one piece of operating information indicates that the secondary electrical machine is currently being operated in neutral mode.

Furthermore, the present disclosure relates to a method for operating a motor vehicle, wherein the motor vehicle may comprise an electrical energy storage device for storing electrical energy and a range extender comprising an internal combustion engine and a generator, wherein the energy storage device is charged by way of the operation of the internal combustion engine using a fossil fuel and using the generator. The method may be implemented in accordance with the disclosure in that the motor vehicle further may include a primary electric machine, by way of which the electric energy stored in the energy storage device may be used to generate a primary drive torque, and a secondary electric machine, by way of which the electric energy stored in the energy storage device may be used to generate a secondary drive torque, wherein the primary drive torque may be transmitted to a drive axle forming a primary axle and the secondary drive torque may be transmitted to a drive axle forming a secondary axle. The secondary electrical machine may be the generator. All the advantages, features and aspects discussed in connection with the motor vehicle according to the present disclosure are equally transferable to method according to the present disclosure and vice versa.

In some embodiments, a generation of control signals, which are used in the context of carrying out the steps of the method according to the disclosure, is carried out by way of software implemented by a control device of the motor vehicle, wherein the software utilizes artificial intelligence, such as trained artificial intelligence. The control device may be connected to the components involved via signal lines. The control device may comprise a computer-readable storage medium and a processing device, wherein the storage medium comprises instructions realizing the software which, when executed by way of the processing device formed as a computer, cause it to perform the corresponding method steps.

The control device may be a component of one of the electrical machines, which is intended for control thereof. The control device may therefore be implemented as a corresponding engine control unit.

### BRIEF DESCRIPTION OF THE SEVERAL VIEWS OF THE DRAWINGS

FIG. 1 is a side view of a motor vehicle according to the present disclosure in accordance with an exemplary embodiment.

FIG. 2 is a schematic representation of the motor vehicle of FIG. 1.

FIG. 3 is a flow chart of a method according to the present disclosure in accordance with an exemplary embodiment, which is carried out in the motor vehicle of FIG. 1.

### DETAILED DESCRIPTION

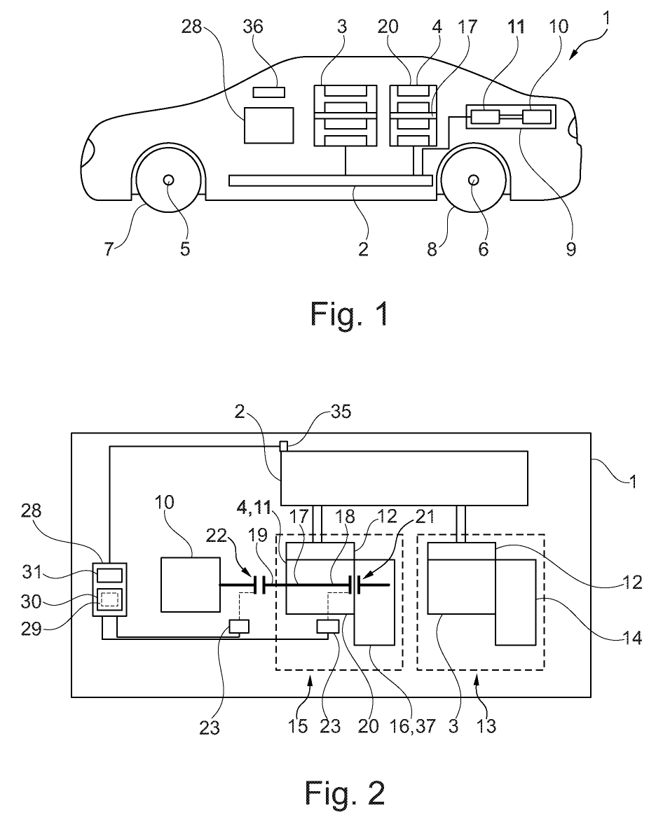

FIG. 1 shows a schematic representation of a side view of a motor vehicle 1 according to the disclosure. The motor vehicle 1 may be configured as an electric vehicle and may have an electrical energy storage device 2, exemplarily configured as a lithium-ion accumulator, for storing electrical energy. In addition, the motor vehicle 1 may comprise a primary electric machine 3, by way of which the electrical energy stored in the energy storage device 2 may be used to generate a primary drive torque. Furthermore, a secondary electrical machine 4 may be provided, by way of which the electrical energy stored in the energy storage device 2 may be used to generate a secondary drive torque.

The primary drive torque, which, in the present embodiment, realizes a main drive torque, may be transmitted to a drive axle of the motor vehicle 1 forming a primary axle 6. The secondary drive torque may be transmitted to a drive axle of the motor vehicle 1 forming a secondary axle 5. The secondary axle 5 may be a front axle of the motor vehicle 1, so that the secondary drive torque may be transmitted to the front wheels 7 of the motor vehicle 1. The primary axle 6 may be a rear axle of the motor vehicle 1, so that the primary drive torque may be transmitted to the rear wheels 8 of the motor vehicle 1. The reverse case is also conceivable within the scope of the present disclosure. The motor vehicle 1 may therefore comprise an all-wheel drive.

To generate the drive torques, electrical energy from the energy storage device 2 may be converted by way of the respective electrical machine 3, 4, wherein each of the electrical machines 3, 4 may be connected to the energy storage device 2 via an inverter 12 for this purpose. The primary electric machine 3 may be integrated into a primary drive train 13 of the motor vehicle 1, which comprises a transmission 14 by way of which the primary drive torque may be transmitted to the rear wheels 8. The secondary electric machine 4 may be integrated into a secondary drive train 15 of the motor vehicle 1, which also comprises a transmission 16 by way of which the secondary drive torque may be transmitted to the front wheels 7. A speed present on the part of a rotor of the respective electric machine 3, 4 may be over-geared or under-geared to a component of the respective drive train 13, 15 by way of the respective transmission 14, 16.

The motor vehicle 1 may comprise a range extender 9 with an internal combustion engine 10 and a generator 11. The energy storage device 2 may be recharged by operating the internal combustion engine 10, which uses a fossil fuel from a fuel tank of the motor vehicle 1. For this purpose, the internal combustion engine 10 may drive a rotor of the generator 11, wherein the electrical energy generated in this way may be transferred from the generator 11 to the electrical energy storage device 2. Although the respective components are shown as separate components in the schematic diagram shown in FIG. 1, it is intended here that the secondary electrical machine 4 forms the generator 11. The secondary electric machine 4 and the generator 11 may be one and the same component of the motor vehicle 1. To illustrate this fact, reference is also made to FIG. 2, which shows a further detailed schematic representation of the motor vehicle 1.

FIG. 2 shows that a rotor shaft 17 of the rotor of the secondary electric machine 4 is coupleable on the one hand to a drive component 37 of the secondary drive train 15, by way of which the secondary drive torque may be transmitted to the wheels 7 of the secondary axle 5 and which is, by way of example, the transmission 16, and on the other hand to the internal combustion engine 10. A drive train-side end 18 of the rotor shaft 17 is coupleable to the transmission 16, while an internal combustion engine-side end 19 of the rotor shaft 17, which may be opposite the drive train-side end 18, is coupleable to the internal combustion engine 10. The internal combustion engine-side end 19 may protrude from a housing 20 of the secondary electrical machine 4.

The secondary electric machine 4 may be brought into a coupled state, in which the secondary electric machine 4 and the drive component 37 or the transmission 16 are coupled, and into a decoupled state, in which the secondary electric machine 4 is decoupled from the drive component 37 or the transmission 16, with respect to the drive component 37 or the transmission 16 by way of a torque coupling device 21. The secondary electric machine 4 may be brought into a coupled state, in which the secondary electric machine 4 and the internal combustion engine 10 are coupled, and into a decoupled state, in which the secondary electric machine 4 is decoupled from the internal combustion engine 10, with respect to the internal combustion engine 10 and by way of a connection coupling device 22. To actuate the coupling devices 21, 22, each may be connected to an electromechanical actuator 23.

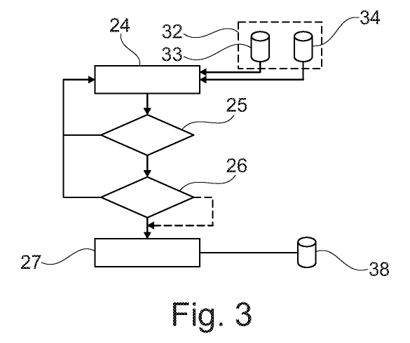

With reference to the flow chart shown in FIG. 3, a method according to the present disclosure is discussed below in accordance with an exemplary embodiment that is carried out on the motor vehicle 1. To carry out steps 24, 25, 26, 27 of the method, a control device 28 of the motor vehicle 1 is provided configured to be connected to the components involved, such as the actuators 23, via signal lines. Specifically, evaluation and control steps that are carried out as part of the implementation of method steps 24, 25, 26, 27 are performed by way of software 29 implemented by the control device 28. The control device 29 comprises a computer-readable storage medium 30 and a processing device 31, wherein the storage medium 30 comprises instructions realizing the software 29 which, when executed by the processing device 31 formed as a computer, cause it to perform the corresponding method steps. The control device 29 is, in this embodiment, a component of the primary electric machine 3 and implements a corresponding engine control unit.

In the first step 24, operating information 32 may be determined, namely charging information 33 and, optionally, user information 34. The charging information 33 may be available as a percentage value relating to the current state of charge of the energy storage device 2, which is also referred to as SoC. To determine the charging information 33, the sensor data of a charge state sensor 35 may be fed to the control device 28. In addition, existing information and/or control commands may be used by a vehicle control system to determine the charging information 33.

The user information 34 may relate to a request from a user or driver of the motor vehicle 1 to operate the secondary electric machine 4 in the charging mode, i.e., to connect the range extender 9. In principle, the request may also relate to operating the secondary electric machine 4 in the drive mode, wherein this case will be discussed again later in the context of a specific example. This case is conceivable, for example, if the user desires both drive torques during driving operation and/or knows that the destination will soon be reached where the energy storage device 2 will be charged. The user may enter the user information 34 by way of an input device 36, which may be a touch screen arranged on a vehicle console forming a dashboard.

The control device 28 may be configured to generate control signals 38 and to output the control signals 38 to the actuators 23 configured to actuate the torque coupling device 21 and the connection coupling device 22, so that the secondary electric machine is operated in a drive mode or in a charging mode or in a neutral mode by way of the control signals 38. The secondary electric machine 4, when in the drive mode, is in the decoupled state with respect to the internal combustion engine 10 and in the coupled state with respect to the drive component 37 or the transmission 16. The secondary electric machine 4, when in the charging mode, is in the coupled state with respect to the internal combustion engine 10 and in the decoupled state with respect to the drive component 37 or the transmission 16. When the secondary electric machine 4 is in the drive mode, the secondary electric machine 4 is decoupled from the internal combustion engine 10 and coupled to the drive component 37 or the transmission 16, so that the secondary drive torque may be generated and transmitted to the front wheels 7 by way of the conversion of the electrical energy provided by the energy storage device 2 by the secondary electric machine 4 using the inverter 12. When the secondary electric machine 4 is in charging mode, the secondary electric machine 4 is coupled to the internal combustion engine 10 and decoupled from the drive component 37 or the transmission 16, so that the energy storage device 2 is charged by way of the conversion of the kinetic energy provided by the internal combustion engine 10 into electrical energy by the secondary electric machine 4. The secondary electric machine 4, when in neutral mode, is in the decoupled state with respect to the internal combustion engine 10 and with respect to the drive component 37 or the transmission 16.

In the following, it is assumed that the secondary electric machine 4 is currently in the drive mode. In the next step 25, the control device 28 may be used to check the fulfillment of a charging condition, which is only fulfilled or may only be fulfilled if the operating information 32 indicates operation of the secondary electric machine 4 in the charging mode would be beneficial, i.e., when the range extender 9 is connected.

The charging condition may be fulfilled if the charging information 33 indicates that the current state of charge is less than a fixed charging limit value. The charging limit value may be selected or specified such that a certain buffer of electrical energy remains in the energy storage device 2 when the charging limit value is reached. In this example embodiment, the charging limit value is 10%. The charging condition may also be fulfilled if the user information 34 indicates that the user wishes for the energy storage device 2 to currently be charged by way of the range extender 9. The user may use the input device 36 to perform an operating action directed towards this purpose, which in turn results in the generation of an operating signal which is transmitted to the control device 28 and which, when this operating signal is present, may determine that the charging condition has been fulfilled.

If the charging condition is not fulfilled, the method is restarted by performing step 24, wherein the information 32, 37 is updated. When the charging condition is fulfilled, the fulfillment of a postponement condition is checked in step 26 by way of the control device 28, which is fulfilled if the operating information 32 indicates that the continued operation of the secondary electric machine 4 in the drive mode is preferable to switching to the charging mode. In other words, it is checked whether there is a valid reason why the switch from drive mode to charging mode should not take place. This is the case, for example, if the operating information 32, which may be determined in this respect on the basis of control signals available from a vehicle control system, indicates that the secondary electric machine 4 is currently in the drive mode or that operation of the secondary electric machine 4 in the drive mode is imminent. In this case, the driver needs the maximum possible drive power and therefore both the primary and secondary drive torque. In contrast, the postponement condition is not fulfilled, for example, if the operating information 32 indicates that the secondary electrical machine 4 is currently in neutral mode.

When the charging condition is fulfilled and the postponement condition is fulfilled, or when the charging condition is not fulfilled, the method is restarted by performing step 24 again, in which the information 32 is updated. In this case, the secondary electrical machine 4 does not switch to charging mode. In particular, said switch is postponed until the charging condition is fulfilled and the postponement condition is not fulfilled.

Nevertheless, when the charging condition is fulfilled and the postponement condition is fulfilled in step 26, before the method is restarted, a check may be performed to determine whether any residual energy available in the energy storage device 2 is so low that the charging mode should not be postponed. This can be the case, for example, if the charging information 33 indicates that the current state of charge is less than a fixed, critical charging limit value, which is less than the charging limit value, which may be 5%, for example. In this case, the result of the check of the postponement condition may be ignored, as indicated by a dashed arrow in FIG. 3, so that the drive mode may be terminated prematurely and immediately and the secondary electric machine 4 may be switched to charging mode. Here, a corresponding user output may also be provided by the input device 28, which informs the user that the drive mode has been terminated.

In the last step 27 of the method, the control device 28 generates the control signals 38 that cause the secondary electrical machine 4 to switch to charging mode. In this case, the method may be considered to be in step 24, wherein the secondary electrical machine 4 is instead in the charging mode, in contrast to the aspects discussed above.

In this step, the fulfillment of a drive condition is checked on the basis of the newly acquired operating information 32. The drive condition may be fulfilled if the charging information 33 indicates that the energy storage device 2 is fully charged or has a charging status that exceeds an upper limit value, for example, 90%. The drive condition may also be fulfilled if the user information 34 indicates that the user wishes for the secondary electric machine 4 to be switched to drive mode at this time. This is the case, for example, when the user briefly floors the gas pedal and thus performs a so-called “kick-down”.

If the drive condition is fulfilled, the fulfillment of the postponement condition is then checked in the next step 26. Analogous to what has been discussed above, said condition is fulfilled if the operating information 32 indicates that the operation of the secondary electric machine 4 in the charging mode is preferable to switching to the drive mode. This is the case, for example, if the charging information 33 indicates that the residual energy currently available in the energy storage device 2 is so low that switching the secondary electric machine 4 to drive mode results in the energy storage device 2 being at least almost completely discharged. In this case, the energy storage device 2 should be charged further.

If the drive condition is not fulfilled or if the drive condition is fulfilled and the postponement condition is fulfilled, the method is restarted in step 24 with the re-acquisition of the operating information. If the drive condition is fulfilled and the postponement condition is not fulfilled, the control signals 38 are generated in the last step 27 of the method by way of the control device 28, so that the secondary electric machine 4 switches to charging mode.

German patent application no. 102025103383.8, filed January 30, 2025, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A motor vehicle, comprising:
an electrical energy storage device configured to store electrical energy;
a range extender comprising an internal combustion engine and a generator;
a primary drive axle;
a secondary drive axle;
a primary electric machine configured to generate a primary drive torque by use of electrical energy stored in the electrical energy storage device, wherein the motor vehicle is configured such that the primary drive torque is transmitted to the primary drive axle; and
a secondary electric machine configured to generate a secondary drive torque by use of the electrical energy stored in the electrical energy storage device, wherein the motor vehicle is configured such that the secondary drive torque is transmitted to the secondary drive axle,
wherein the electrical energy storage device is configured to be charged by way of operation of the internal combustion engine using a fossil fuel and use of the generator, and
wherein the secondary electric machine forms the generator.

2. The motor vehicle according to claim 1, wherein the primary drive axle is a rear axle and the secondary drive axle is a front axle of the motor vehicle, or
wherein the primary drive axle is the front axle and the secondary drive axle is the rear axle of the motor vehicle.

3. The motor vehicle according to claim 1, wherein the primary electric machine is incorporated in a primary drive train, the primary drive train configured to transmit the primary drive torque to wheels of the primary drive axle, and/or
wherein the secondary electric machine is incorporated in a secondary drive train, the secondary drive train configured to transmit the secondary drive torque to wheels of the secondary drive axle.

4. The motor vehicle according to claim 3, wherein a rotor shaft of the secondary electric machine is configured to be selectively coupled to a drive component of the secondary drive train, the drive component of the secondary drive train configured to transmit the secondary drive torque to the wheels of the secondary axle, and
wherein the rotor shaft of the secondary electric machine is configured to be selectively coupled to the internal combustion engine.

5. The motor vehicle according to claim 4, wherein the drive component is a transmission.

6. The motor vehicle according to claim 4, wherein the secondary electrical machine is configured to be brought into a drive component coupled state and a drive component decoupled state,
wherein the drive component coupled state includes the secondary electrical machine and the drive component being coupled, and
wherein the drive component decoupled state includes the secondary electrical machine being decoupled from the drive component by way of a torque coupling device.

7. The motor vehicle according to claim 6, wherein the secondary electrical machine is configured to be brought into an internal combustion engine coupled state and an internal combustion engine decoupled state,
wherein the internal combustion engine coupled state includes the secondary electrical machine and the internal combustion engine being coupled, and
wherein the internal combustion engine decoupled state includes the secondary electrical machine being decoupled from the internal combustion engine by way of a connection coupling device.

8. The motor vehicle according to claim 7, further comprising:
a control device configured to generate control signals and to output the control signals to actuators configured to selectively actuate the torque coupling device and the connection coupling device, such that the secondary electrical machine is configured to be selectively operated in a drive mode and a charging mode by way of the control signals,
wherein the drive mode includes the secondary electric machine in the internal combustion engine decoupled state and in the drive component coupled state, and
wherein charging mode includes the secondary electric machine in the internal combustion engine coupled state and in the drive component decoupled state.

9. The motor vehicle according to claim 8, wherein the control device is configured to determine operating information of the motor vehicle and to use the operating information to check the fulfillment of a charging condition and the fulfillment of a drive condition,
wherein the charging condition is fulfilled when the operating information indicates a benefit of operating the secondary electric machine in the charging mode,
wherein the drive condition is fulfilled when the operating information indicates a benefit of operating the secondary electrical machine in the drive mode, and
wherein the control device is configured to generate the control signals such that the secondary electrical machine is transferred to, or continues in, the charging mode when the charging condition is fulfilled and is transferred to, or continues in, the drive mode when the drive condition is fulfilled.

10. The motor vehicle according to claim 9, wherein the operating information includes charging information including a current state of charge of the electrical energy storage device, and
wherein the charging condition is fulfilled if the charging information indicates that the current state of charge is less than a specified charging limit value.

11. The motor vehicle according to claim 9, the operating information includes user information including a desired operation mode of the second electrical machine of a user,
wherein the charging condition is fulfilled if the user information indicates that the desired operation mode of the secondary electrical machine is the charging mode, and
wherein the drive condition is fulfilled if the user information indicates that the desired operation mode of the secondary electrical machine is the drive mode.

12. The motor vehicle according to claim 9, wherein the control device is configured to check the fulfillment of a postponement condition when the charging condition or the drive condition is fulfilled,
wherein the postponement condition is fulfilled when the charging condition is fulfilled, if the operating information indicates that operation of the secondary electrical machine in the drive mode is preferable to switching to operation of the secondary electrical machine in the charging mode,
wherein the postponement condition is fulfilled when the drive condition is fulfilled, if the operating information indicates that operation of the secondary electrical machine in the charging mode is preferable to switching to operation of the secondary electrical machine in the drive mode, and
wherein the control device is configured to postpone or omit the control signals causing the secondary electrical machine to switch to a respective operation mode when the postponement condition is fulfilled.

13. The motor vehicle according to claim 12, wherein the postponement condition is fulfilled when the drive condition is fulfilled, if the operating information indicates that a residual energy available in the electrical energy storage device is below a minimum level, such that switching the secondary electrical machine to drive mode would result in the electrical energy storage device being discharged below a minimum discharge level; and/or
the postponement condition is fulfilled when the charging condition is fulfilled, if the operating information indicates that the secondary electrical machine is currently in the drive mode or that operation in the drive mode is imminent.

14. A method for operating a motor vehicle, the method comprising:
charging an electrical energy storage device of the motor vehicle by way of operation of an internal combustion engine of a range extender using fossil fuel and use of a generator of the range extender, the electrical energy storage device configured to store electrical energy;
generating a primary drive torque by way of a primary electric machine of the motor vehicle using the electrical energy stored in the electrical energy storage device;
generating a secondary drive torque by way of a secondary electric machine of the motor vehicle using the electrical energy stored in the electrical energy storage device;
transmitting the primary drive torque to a primary drive axle; and
transmitting the secondary drive torque to a secondary drive axle,
wherein the secondary electric machine forms the generator.
